(19) United States
(12) Patent Application Publication
(10) Pub. No.: US 2026/0241755 A1
(43) Pub. Date: Aug. 20, 2026

(54) TRAILER TIRE ROTATIONAL INDICATOR

(71) Applicant: Ronnie William Metz, Prince George (CA)

(72) Inventor: Ronnie William Metz, Prince George (CA)

(21) Appl. No.: 19/056,069

(22) Filed: Feb. 18, 2025

(51) Int. Cl. B60C 19/00

(52) U.S. Cl. CPC B60C 19/00

(57) ABSTRACT

A tire rotation indicator configured to be releasably secured to a trailer tire wherein the present invention provides a visual indicator of proper rotation of the trailer tire including at night. The indicator includes a body wherein the body is elongated and rectangular in shape having a first end and a second end. The body has an aperture formed in the first end wherein a fastener is surroundably present the aperture. The fastener is configured to releasably secure the body to a wheel lug of a trailer tire. The second end of the body has embedded therein a reflective member. The reflective member in a preferred embodiment is silver in color and manufactured of a suitable reflective material. The reflective member is rectangular in shape and embedded in the second end of the body utilizing suitable techniques.

### FIELD OF THE INVENTION

The present invention relates generally to trailer safety, more specifically but not by way of limitation a tire rotational indicator wherein the present invention is operably coupled to trailer tires and provides indication rotational movement of a trailer tire and further includes reflective portions or light members to enhance visibility at night.

### BACKGROUND

The operation of a tractor-trailer presents significant challenges, particularly in maintaining control during adverse driving conditions. One of the most critical issues affecting driver safety and vehicle performance is tire skidding and the complete stoppage of tire rotation. These occurrences significantly impact the driver’s ability to maneuver the trailer safely, posing dangers not only to the truck operator but also to other motorists on the road. Understanding the mechanics behind tire skidding, the causes and effects of rotational stoppage, and the measures to mitigate these risks is crucial in enhancing road safety. Tire skidding occurs when the traction between the tire and the road surface is insufficient to maintain proper movement. This often happens when a driver applies excessive braking force, causing the tires to lock up. When the tires stop rotating but the vehicle continues to move forward due to inertia, a skidding effect takes place. This significantly reduces the driver's ability to steer the trailer effectively, as directional control is largely dependent on rolling friction rather than sliding friction.

Several factors contribute to the skidding of tractor-trailer tires. Poor road conditions, such as icy or wet surfaces, decrease traction and increase the likelihood of skidding. Additionally, excessive braking, particularly when the anti-lock braking system is malfunctioning or absent, can lead to tire lock-up. Improper loading and distribution of cargo may also contribute by shifting the vehicle’s center of gravity, thereby affecting stability and increasing the chances of tire slippage. When tire rotation ceases entirely due to skidding, the effects on vehicle control are severe. Steering effectiveness is drastically reduced, making it nearly impossible for the driver to maintain the intended direction. Additionally, uncontrolled skidding can result in jackknifing, where the trailer swings out at an angle to the tractor, posing a grave risk of collision. In extreme cases, skidding can lead to rollovers, particularly if the vehicle is negotiating a curve or if the road surface is uneven.

Preventing tire skidding and rotation stoppage requires adherence to proper driving techniques and vehicle maintenance practices. The implementation of anti-lock brake systems in modern tractor-trailers has significantly reduced the risk of wheel lock-up by allowing controlled braking. Drivers should also practice safe braking techniques, such as gradual and controlled deceleration, rather than sudden stops. Furthermore, proper tire maintenance, including regular pressure checks and tread inspections, ensures optimal traction. Load distribution should be managed carefully to maintain a stable center of gravity, reducing the risk of skidding due to weight imbalances. Training programs emphasizing defensive driving techniques, particularly in adverse weather conditions, can further equip drivers with the skills necessary to handle skidding situations effectively. Tire skidding and rotational stoppage in tractor-trailers present significant dangers that compromise driver control and road safety. The reduction in steering capability, increased risk of jackknifing, and potential rollovers highlight the need for preventive measures. While technology and safe practices are good measures to assist drivers, additional safety devices especially devices configured to help drivers at night are needed.

Accordingly, there is a need for a trailer tire rotational indicator that is releasably secured to a trailer tire that has improved visibility at night so as to allow an operator to quickly ascertain the rotational status of a trailer tire.

### SUMMARY OF THE INVENTION

It is the object of the present invention to provide a tire rotational indicator configured to be operably coupled to a trailer tire wherein the present invention includes a body manufactured from a rigid material such as but not limited to metal.

Another object of the present invention is to provide a tire status indicator coupled to a trailer tire to provide rotational movement monitoring wherein the body of the present invention is elongated and rectangular in shape.

A further object of the present invention is to provide a tire rotational indicator configured to be operably coupled to a trailer tire wherein the body includes a first end and a second end wherein the first end includes a fastening member formed thereon.

Yet a further object of the present invention is to provide a tire status indicator coupled to a trailer tire to provide rotational movement monitoring wherein the body includes a reflective member secured to the second end.

Still another object of the present invention is to provide a tire rotational indicator configured to be operably coupled to a trailer tire wherein the body includes a first side and a second side.

An additional object of the present invention is to provide a tire status indicator coupled to a trailer tire to provide rotational movement wherein the reflective member is secured to the second side of the body.

Yet a further object of the present invention is to provide a tire rotational indicator configured to be operably coupled to a trailer tire wherein the reflective member is inset into the second end of the body.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of the present invention; and

FIG. 2 is a rear view of the present invention; and

FIG. 3 is a perspective view of the present invention operably coupled to trailer tires.

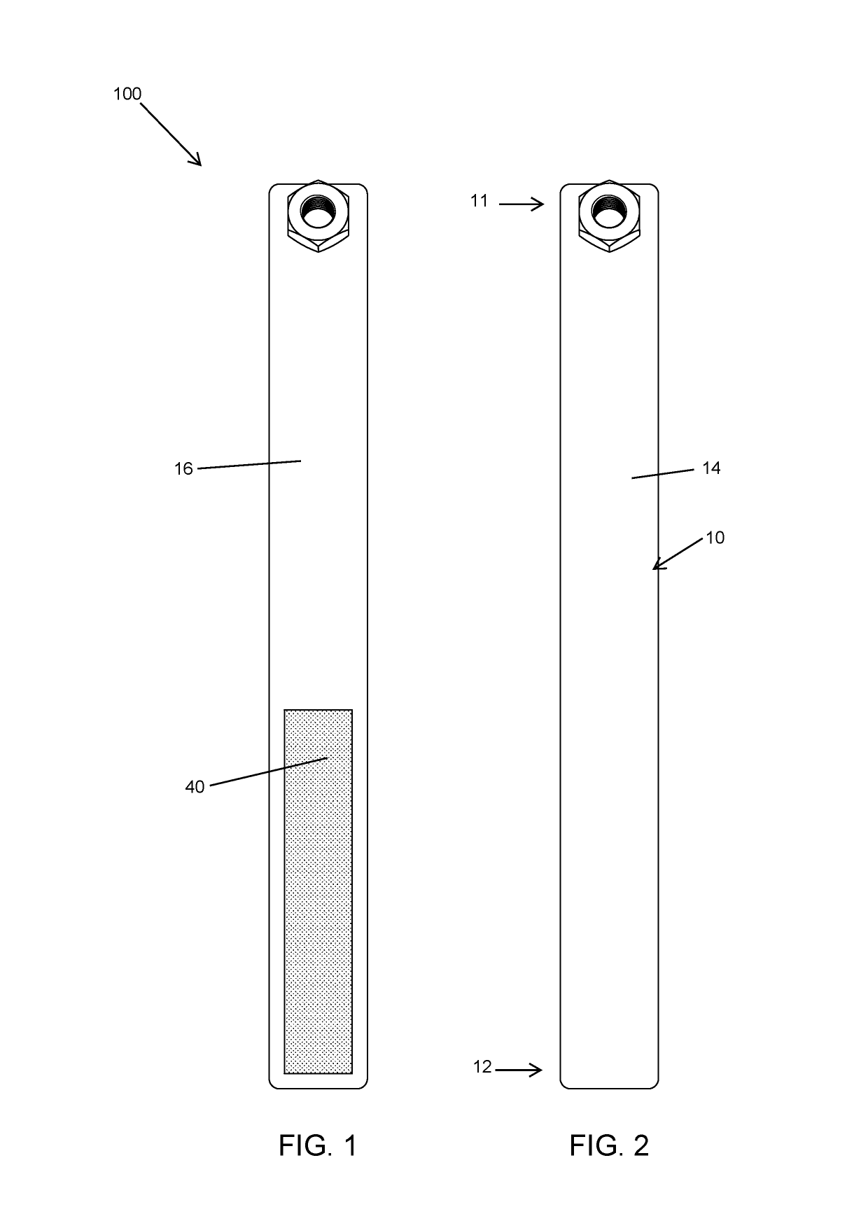

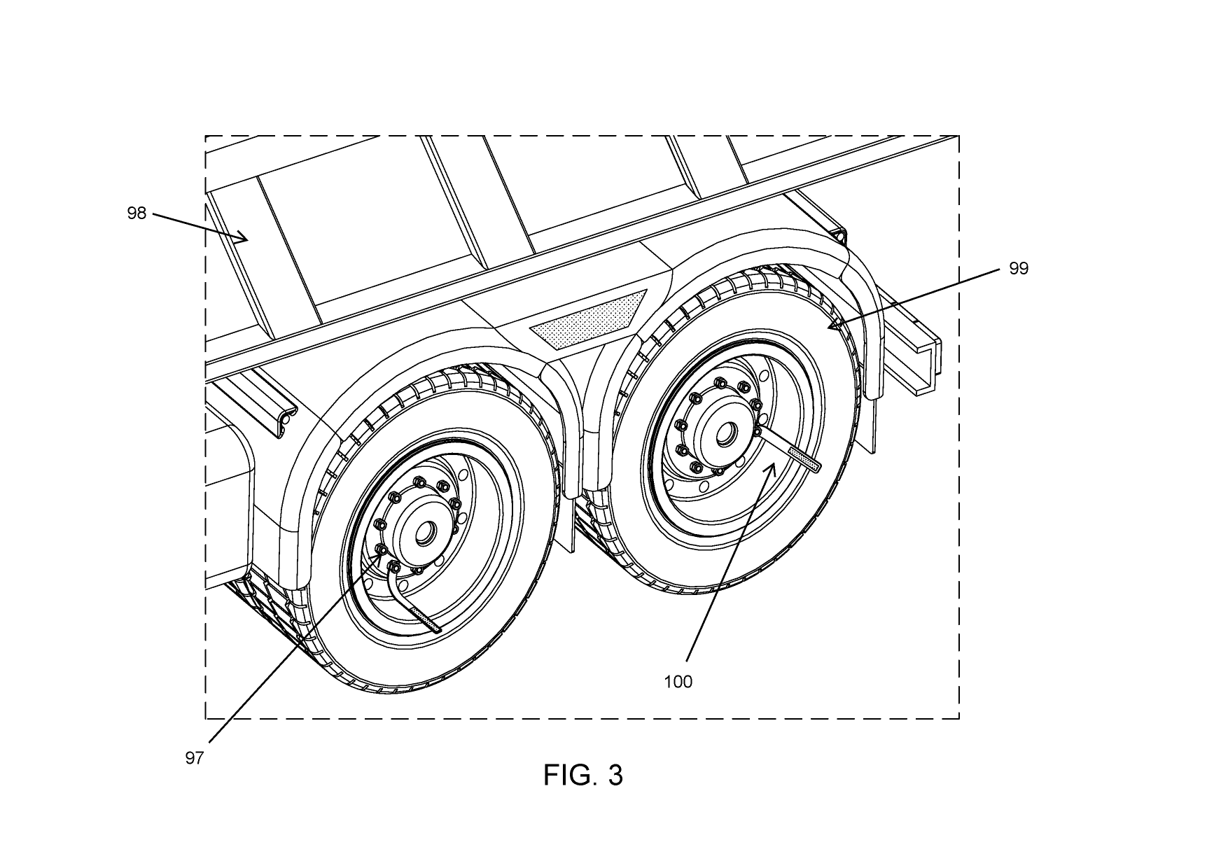

### DETAILED DESCRIPTION

Referring now to the drawings submitted herewith, wherein various elements depicted therein are not necessarily drawn to scale and wherein through the views and figures like elements are referenced with identical reference numerals, there is illustrated a tire rotational indicator 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the tire rotational indicator 100 is configured to be operably coupled to trailer tires 99 and provide a visual indicator of proper rotation of the tires during use of the trailer 98. The tire rotational indicator 100 includes a body 10 wherein the body 10 includes a first end 11 and a second end 12. The body 10 is manufactured from a durable rigid material such as but not limited to metal. The body 10 is elongated and rectangular in form being of suitable length to extend beyond the trailer tire 99 so as to enable an operator in the cab an ability to see the tire rotational indicator 100. It should be understood within the scope of the present invention that the body 10 could be provided in alternate lengths and achieve the desired objective discussed herein.

The body 10 includes a first side 14 and second side 16. An aperture 20 is formed in the first end 11 of the body 10 utilizing suitable techniques. The aperture 20 has surroundably present thereto a fastener 24. The fastener 24 is configured to facilitate the releasably securing of the tire rotational indicator 100 to the wheel lugs 97. It is contemplated within the scope of the present invention that the tire rotational indicator 100 could utilize various alternate types of fasteners to releasably secure the body 10 to the wheel lugs 97.

Formed on the second end 12 of the body 10 is reflective member 40. The reflective member 40 is integrally formed in the second end 12 of the body 10 utilizing suitable techniques. In a preferred embodiment of the present invention the reflective member 40 is embedded into the body 10 so as to maintain a consistent position thereon. The reflective member 40 is elongated and rectangular in shape and is manufactured from suitable reflective material such as but not limited to glass beads or prisms. While the reflective member 40 can be provided in various colors, in a preferred embodiment of the present invention the reflective member 40 is silver in color. While the reflective member 40 is disclosed herein as being rectangular in shape, it is contemplated within the scope of the present invention that the reflective member 40 could be provided in alternate shapes and sizes. It is further contemplated within the scope of the present invention that the reflective member 40 could be manufactured from a light emitting member such as but not limited to a LED light having an integrated power supply therein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A trailer tire rotational indicator configured to provide visual indication of trailer tire rotational status wherein the trailer tire rotational indicator comprises:
a body, said body being elongated and rectangular in form, said body having a first end and a second end, said body having a first side and a second side, said body having an aperture formed therein at said first end thereof, said body further having a fastener, said fastener being surroundably present to said aperture;
a reflective member, said reflective member being proximate said second end of said body, said reflective member being embedded in said body, said reflective member being manufactured from a reflective material to facilitate visibility in low light and dark environments.

2. The trailer tire rotational indicator configured to provide visual indication of trailer tire rotational status as recited in claim 1, wherein said reflective member is rectangular in shape.

3. The trailer tire rotational indicator configured to provide visual indication of trailer tire rotational status as recited in claim 2, wherein said reflective member is silver in color.

4. The trailer tire rotational indicator configured to provide visual indication of trailer tire rotational status as recited in claim 3, wherein said body is manufactured from metal.
